(19) United States
(12) Patent Application Publication
(10) Pub. No.: US 2018/0022623 A1
(43) Pub. Date: Jan. 25, 2018

(54) METHOD OF EXTENDING TAILINGS POND LIFE

(71) Applicant: Tronox Alkali Wyoming Corporation, Stamford, CT (US)

(72) Inventors: Gary Lee Mortensen, Green River, WY (US); Thomas Richard Findlow, Green River, WY (US)

(73) Assignee: Tronox Alkali Wyoming Corporation, Stamford, CT (US)

(21) Appl. No.: 15/722,534

(22) Filed: Oct. 2, 2017

Related U.S. Application Data
(63) Continuation of application No. 13/020,244, filed on Feb. 3, 2011.

(51) Int. Cl. C02F 1/66

(52) U.S. Cl. CPC C02F 1/66; C02F 2103/007

(57) ABSTRACT

The present invention is directed to a method for extending the life of tailings ponds produced from purge streams containing inorganic salts such as sodium carbonate, which method comprises treating such purge stream with gaseous carbon dioxide. This treatment converts the sodium carbonate into sodium bicarbonate. As the pond evaporates, the sodium bicarbonate will take up only about 40 percent of the volume of the sodium carbonate decahydrate that is formed by the drying of sodium carbonate.

### CROSS REFERENCE TO RELATED APPLICATION

This application claims the benefit of U.S. application Ser. No. 13/020,244 filed on Feb. 3, 2011 which claims the benefit of U.S. Provisional Patent Application No. 61/311,833, filed Mar. 9, 2010, the entirety of each is hereby incorporated by reference into this application.

### FIELD OF THE INVENTION

The present invention relates to a method of extending the life of tailing ponds containing inorganic salt brines from the purge streams of soda ash or similar production facilities. This method is accomplished by treatment of either the water present in such ponds and/or the purge streams feeding into such ponds with carbon dioxide. An additional benefit of such process is the sequestration of carbon dioxide gas.

### BACKGROUND OF THE INVENTION

The production of soda ash from trona typically results in the production of large aqueous process purge and tailings slurry streams containing sodium carbonate as well as soluble impurities such as sodium chloride, sodium sulfate, and organic substances derived from the shale levels that exist between the trona beds. Although technologies can be applied to recover certain amounts of such sodium carbonate, ultimately the cost and difficulty of obtaining commercial grade sodium carbonate from such impure streams increases to such a degree that recovery is not commercially practical.

Typically, such purge and tailings slurry streams are deposited in tailings ponds that may cover many acres. Over time, the water in such ponds evaporates, leaving behind the impurities and sodium carbonate. Much of this sodium carbonate is deposited in the form of sodium carbonate decahydrate (deca), a crystalline compound containing ten moles of water for each mole of sodium carbonate. Because of this high-water content and low density, deca takes up considerable volume in the pond, eventually forcing the mine owner to undertake expensive removal steps and/or to make major expenditures to build additional ponds.

Accordingly, there is a need in the industry for a means to extend the life of such tailings ponds in order to avoid or reduce the expenses associated with such deca buildup.

### SUMMARY OF THE INVENTION

The present invention is directed to a method for extending the life of tailings ponds produced from purge and tailings slurry streams containing inorganic salts such as sodium carbonate, which method comprises treating such streams and/or aqueous streams from such ponds (collectively ‘Purge Streams’) with gaseous carbon dioxide.

In one embodiment of this invention, the purge stream is treated with carbon dioxide prior to its being deposited in the tailings pond.

In another embodiment, the purge stream is treated with carbon dioxide after its deposit in the tailings pond—i.e., water in the tailings pond containing sodium carbonate is treated with carbon dioxide and is then returned to the tailings pond or the carbon dioxide is added directly to the sodium carbonate containing water in the pond.

### DETAILED DESCRIPTION OF THE INVENTION

The present invention is directed to a method for extending the life of tailings ponds produced from purge streams containing sodium carbonate, which method comprises treating such purge streams with gaseous carbon dioxide.

In one embodiment of this invention, the purge stream is treated prior to its deposit into the tailing pond; whereas in another embodiment, the purge stream is treated after deposit. In this later embodiment, water containing sodium carbonate is removed from the pond, treated with carbon dioxide, and recycled back into the pond; or the carbon dioxide is added directly to the water in the pond.

The purge streams containing sodium carbonate may come from any or several streams associated with the mining of trona, nahcolite, or other sodium-containing mineral; and the conversion of such minerals into soda ash. Thus, for example, such purge streams may result from the solution mining of trona by processes well known to those of skilled in the art; from processes for the beneficiation of trona; from processes for the recovery of sodium carbonate from existing waste streams; or from any other process that creates an aqueous purge stream containing sodium carbonate.

The purge streams are treated with a gas containing carbon dioxide such that the sodium carbonate in the purge stream is converted into a carbonated specie that will crystallize with less waters of hydration. The reaction of sodium carbonate with water and carbon dioxide to form carbonated species such as sodium bicarbonate and sodium sesquicarbonate have long been known, and one skilled in the art could easily optimize the process parameters which include:
Liquor pH. Inlet liquor pH may be high, even nearing 14 in caustic solutions but will lower as carbonation proceeds. Liquor carbonation will reach a pH of about 8.4 as the alkalinity converts fully to sodium bicarbonate. Target pH will be dependent upon the optimization applied to this invention.
Pressure. Conversion rate of sodium carbonate/hydroxide to bicarbonate is increased as the partial pressure of carbon dioxide increases; hence, pressurized reactors are favored as is direct carbon dioxide injection into the deepest portion of a tailings pond.
Temperature. Higher temperature favors sodium bicarbonate conversion kinetics and its solubility in aqueous solutions. As the temperature is lowered, carbon dioxide dissociation from the liquor is reduced and sodium bicarbonate will reach a saturation temperature and crystallize.
Concentration. At high sodium carbonate concentrations, carbonation initially produces sodium sesquicarbonate until the sodium bicarbonate phase boundary is met. Pond solids deposition will be similar per unit of sodium carbonate as on weaker solutions, but the amount of carbon dioxide consumed will be lowered. To maximize the consumption of carbon dioxide, sodium carbonate concentration should be more than about ⅔^{rd} of a saturated solution.

The carbon dioxide gas employed is typically that produced by natural soda ash refining processes, such as off-gas from trona calcination processes or boiler flue gas from on-site energy production, with the purge stream being used to absorb the carbon dioxide and reduce the greenhouse gas emissions from the site. As is employed herein, the term “trona calcination processes” is intended to include carbon dioxide stripping from alkaline brines and slurries. However, any source of carbon dioxide gas can be employed.

Treatment of the purge stream with carbon dioxide converts a substantial amount of the sodium carbonate contained in the purge stream into sodium bicarbonate or sesquicarbonate. As a result, when the water evaporates from the pond, an increased amount of the sodium is crystallized in a carbonated specie that will result in a corresponding reduction in deca formation. For example, sodium bicarbonate only occupies about 40% of the volume taken up by deca with an equivalent amount of sodium; such treatment can greatly extend the life of a tailing pond.

Further, such sodium bicarbonate produced via the carbon dioxide treatment may be recovered prior to its introduction into the tailings pond or recovered after its deposition into the pond, providing a source of income as well as further extending tailing pond life. In addition, as noted above, the formation of sodium bi-carbonate ties up and sequesters significant amounts of carbon dioxide, permitting the plant operator to greatly reduce the amount of greenhouse causing gases released to the atmosphere.

### EXAMPLES

### Example 1

A 1.5 liter stainless steel pressure filter vessel was prepared by installing filter paper on its outlet. A glass tube with fritted glass end for CO₂ addition; a pH probe to measure carbonation effectiveness; and a thermocouple to track liquor temperature; were inserted through an opening in the top of the vessel housing.

A 1,272.42 gram sample of a purge liquor (comprising those weight percentages of Na₂CO₃, NaHCO₃, NaCl and Na₂SO₄ set forth in Table 1) was heated to 37° C., and poured into the top of the vessel housing. The liquor was carbonated by bubbling carbon dioxide through it for 4 hours which dropped the pH from 9.53 to 7.51. Since a sodium bicarbonate solution normally has a pH around 8.3, it was assumed that the sodium carbonate present in the solution was completely carbonated. During this time, the temperature of the liquor dropped slightly, from 37° C. to 32° C. The carbon dioxide sparger had to be removed and cleaned twice due to crystals forming on the fritted glass.

Following carbonation, the vessel was placed into an ice water bath until the carbonated liquor was cooled to 5.6 deg. C. The liquor and solids were then separated by pressurizing the filter with air forcing the liquor through the filter medium. The filter cake weighed 297.20 gm and the liquor phase was 986.64 gm. Both samples were analyzed with the results summarized in Table 1 below.

A 1,160.1 gm aliquot of the purge liquor employed in Example 1 was heated to about 37° C. and poured into the top of the vessel housing of the pressure filter vessel employed in Example 1. The filter housing was then placed into an ice water bath and cooled to 5.4° C., it was then removed from the bath and the filter cake separated from the liquor using air pressure to force the liquor through the filter medium. The filter cake and the liquor were both analyzed, with the results being presented in Table 1 below.

### Calculations

For comparison purposes, the results obtained from Example 1 and Comparative Experiment A were normalized to a quantity of 1000 gm of starting liquor. This calculation indicated that employing a 1000 gm sample would result in 233.9 gm of solids in the carbonated sample (Example 1) and 308.6 gm of solids in the non-carbonated sample (Comparative Experiment A). This would indicate that the solids from a carbonated purge liquor would have only 0.76 the mass of the solids from the same liquor without carbonation.

Assuming that the sodium carbonate and sodium sulfate species would be present as decahydrates, the volume differences of such normalized results were calculated. In performing such calculations, a density of 1.460g/cm³ was assumed for Na₂CO₃.10H₂O; a density of 2.165 g/cm³ was assumed for Na₂SO₄.10H₂O; a density of 2.200 g/cm³ was assumed for NaHCO₃; a density of 2.165 g/cm³ was assumed for NaCl; and that the remainder of the solids constituted free water (having a density of 1.000 g/cm³. Employing such assumptions, the total cake volumes were calculated as 145.3 cm³ for the carbonated sample (Example 1) and 238.6 cm³ for the non-carbonated sample (Comparative Experiment A). This calculation indicates that the solids from the carbonated liquor only require about 61% of the space of the solids of the non-carbonated liquor.

TABLE 1
Experiment to Determine Capability of a Carbonation Process to Reduce
the Volume of Solids Being Deposited in a Tailings Pond.

| | Sample | Na₂CO₃ | NaHCO₃ | NaC1 | Na₂SO₄ |
|---|---|---|---|---|---|
| | Weight | Weight | Weight | Weight | Weight |
| Sample | (grams) | % | % | % | % |
| Example 1. Starting Purge Liquor | 1270.42 | 10.11% | 3.20% | 10.84% | 1.18% |
| Carbonated to 7.5 pH then Cooled to 5.6 | | | | | |
| Deg. C. | | | | | |
| Filter Cake | 297.20 | 0.84% | 56.85% | 10.71% | 0.58% |
| Liquor Phase | 986.64 | 0.87% | 2.93% | 12.43% | 1.29% |
| Comparative Experiment A | 1160.05 | 10.11% | 3.20% | 10.84% | 1.18% |
| Starting Purge Liquid | | | | | |
| Not Carbonated, Cooled to 5.4 Deg. C. | | | | | |
| then Filtered in same Pressured filter | | | | | |
| as Sample 1. | | | | | |
| Filter Cake | 357.99 | 19.92% | 1.90% | 7.00% | 1.32% |
| Liquor Phase | 801.29 | 05.62% | 3.72% | 12.86% | 1.10% |
| Normalize to 1000 grams, | | | | | |
| Weight Calculations | | | | | |
| Initial Sample Basis: | 1000.00 | | | | |
| Carbonated Cake | 233.94 | 0.84% | 56.85% | 10.71% | 0.58% |
| Carbonated Liquor Phase | 776.63 | 0.87% | 2.93% | 12.43% | 1.29% |
| Non-Carbonated Cake | 308.60 | 19.92% | 1.90% | 7.00% | 1.32% |
| Non-Carbonated Liquor | 690.74 | 5.62% | 3.72% | 12.86% | 1.10% |

1-7. (canceled)

8. A method for extending the life of a tailings pond by reducing the amount of sodium carbonate decahydrate in the tailings pond, the tailings pond formed by depositing an aqueous process purge stream and/or a tailings slurry stream wherein the purge stream and/or tailings slurry stream contains sodium carbonate and are associated with the mining of trona, nahcolite, or other sodium containing mineral, the method consisting essentially of treating the aqueous process purge and/or tailings waste slurry streams prior to it being deposited in the tailing pond or subsequent to it being deposited in the tailing pond with gaseous carbon dioxide to react sodium carbonate with water and carbon dioxide thereby forming a carbonated species selected from the group consisting of sodium bicarbonate and sodium sesquicarbonate, that will crystallize with less waters of hydration and thereby reduce the amount of sodium carbonate decahydrate in the tailings pond.

9. The method of claim 8 wherein the purge stream is treated with carbon dioxide until its pH is lower than about 8.4.
